(19) United States
(12) Patent Application Publication
(10) Pub. No.: US 2009/0082994 A1
(43) Pub. Date: Mar. 26, 2009

(54) Headset With Integrated Pedometer and Corresponding Method

(75) Inventors: Francesca Schuler, Des Plaines, IL (US); Mohamed I. Ahmed, Glendale Heights, IL (US); Mark Cholewcynski, Wheaton, IL (US); Krishna Jonnalagadda, Algonquin, IL (US); Xun Luo, Cicero, IL (US); Swee Mok, Palatine, IL (US); Kaidi Zhao, Schaumburg, IL (US)

Correspondence Address: MOTOROLA/FETF, 120 S. LASALLE STREET, SUITE 1600, CHICAGO, IL, 60603-3406, US

(73) Assignee: MOTOROLA, INC., Schaumburg, IL (US)

(21) Appl. No.: 11/861,095

(22) Filed: Sep. 25, 2007

(51) Int. Cl. G01C 22/00

(52) U.S. Cl. 702/160

(57) ABSTRACT

A headpiece (101) has at least one pedometer accelerometer (102) integrally disposed with respect to the headpiece (101) and a personal communications device interface (103) operably supported by the headpiece (101). By one approach, the headpiece (201) has an earpiece having at least one audio transducer (204). By another approach, the pedometer accelerometer (402) is disposed substantially dorsally with respect to the user's head (413) when the headpiece (401) is supported by the user's head (413).

### TECHNICAL FIELD

This invention relates generally to bio-sensors and more particularly to a wearable pedometer and method of use.

### BACKGROUND

Many people, whether avid runners, joggers, or average pedestrians concerned about their health employ devices such as pedometers to track the number of steps (and/or the cumulative distance) they have traveled. Many of these pedometers are single-purpose devices that are worn somewhere on or near the legs or feet in order to track pedometric data.

Unfortunately, many of these same people have also begun to carry an increasing amount of unrelated gadgetry with them. Wireless telephones, personal data assistants, and music players of various kinds, for example, have all become standard equipment for many people regardless of their activity of the moment. When carried along with a standard pedometer, such a collection of single-purpose devices often results in inconvenient bulk, particularly for exercising runners and walkers who prefer not to be encumbered in such a manner. Additionally, leg-worn pedometers are difficult to read while moving, such that the user who wishes to know his progress must interrupt his walk, run, or jog in order to check the pedometer reading.

An attempted solution has been to combine single-use devices into one multi-purpose device so that a person need carry fewer accessories. While combining a pedometer with a primarily handheld device such as a cell phone may cut down on the number of devices carried, however, the utility of the pedometer is impaired. Over the course of a single excursion, a cell phone may be carried in any number of locations on a person's body, such as on the belt, on an arm band, in ajacket pocket, or in the hand while talking. Such a variety of possible locations presents extreme difficulty in calibration and activity tracking, and can result in false positives or other data anomalies. Even if the device is worn in the same place through the entirety of the day, such as on the user's belt, the user will often have to move the device to check his or her progress, thus potentially providing more false positives or resulting in further lost data.

### BRIEF DESCRIPTION OF THE DRAWINGS

The above needs are at least partially met through provision of the headset with integrated pedometer described in the following detailed description, particularly when studied in conjunction with the drawings, wherein:

FIG. 1 comprises a schematic view as configured in accordance with various embodiments of the invention;

FIG. 2 comprises a side perspective view as configured in accordance with various embodiments of the invention;

FIG. 3 comprises a side perspective view as configured in accordance with various embodiments of the invention;

FIG. 4 comprises a rear elevation view as configured in accordance with various embodiments of the invention; and

FIG. 5 comprises a flowchart as arranged in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a headpiece configured and arranged to be supported by a user's head has at least one pedometer accelerometer integrally disposed with respect to the headpiece and a personal communications device interface operably supported by the headpiece. By one approach, the headpiece may comprise, at least in part, an earpiece comprising at least one audio transducer. As illustrative examples, such an audio transducer may comprise a speaker, microphone, or both. By a further approach, the pedometer accelerometer may be disposed substantially dorsally with respect to the user's head when the headpiece is supported by the user's head.

In various approaches, the personal communications device may comprise at least one wireless interface or non-wireless interface. By a further approach, the personal communications device interface may be configured and arranged to locally interface with a personal communications device. Those skilled in the art will appreciate that such local interfacing is scalable to encompass local interfaces ranging from a personal scale to a neighborhood or municipal scale, and may include interfacing with a plurality of personal communications devices. Those skilled in the art will also realize that a number of protocols may be used for such a wireless interface, such as, for example, 802.11-based protocols, Bluetooth, ZigBee, and the like. By a still further approach, the personal communications device interface may be further configured and arranged to receive processed pedometer information regarding the user from the personal communications device.

By another approach, a signal processor may be operably coupled to the pedometer accelerometer. By a further approach, at least one non-pedometric biosensor may be integrally disposed with respect to the headpiece. In various approaches, this at least one non-pedometric biosensor may comprise, at least in part, a heart rate sensor (such as for example a photoplethysmograph sensor), a temperature sensor, or an acoustic sensor, to note but a few examples in this regard. In a still further approach, the signal processor may be arranged, at least in part, to process both pedometer accelerometer data and non-pedometric biosensor data as a function, at least in part, of data from the pedometer accelerometer. Those skilled in the art will appreciate that this leveraging of the signal processor and accelerometer data could be put to a variety of uses, such as removing motion artifacts from heart rate sensor data as a function of pedometer accelerometer data.

As another approach, the signal processor may be configured and arranged to substantively verify processed pedometer data as a function, at least in part, of non-pedometric data. As an illustrative example, if a user is engaged in physical activity, the user's heart rate is likely to be elevated. This data could be compared against the processed pedometer data to verify, for example, that the user was indeed running. Those skilled in the art will recognize that a wide variety of non-pedometric data could be utilized to verify the processed pedometer data, including for example user calendar information, user location information (such as for example global positioning system (GPS) information), hydration levels of the user, body temperature of the user, the user's galvanic skin response, and so forth.

By yet another approach, the signal processor may be configured and arranged to selectively operate in each of a learning mode of operation and a normal mode of operation, wherein the learning mode of operation comprises, at least in part, developing at least one characteristic model of pedometer accelerometer data as corresponds to at least one ambulatory mode of the user. As an illustrative example, the user could select that the signal processor operate in a learning mode while the user runs. The signal processor could then develop a model of pedometer accelerometer data that corresponded to the user running.

By a further approach, the normal mode of operation may comprise, at least in part, using the at least one characteristic model of pedometer accelerometer data to process pedometer accelerometer data. By still another approach, the pedometer accelerometer data could be processed to provide pedometer information regarding the user. With reference to the same illustrative example as above, the user could select that the signal processor operate in a normal mode while the user runs. The signal processor could then reference the characteristic model to accurately determine how many steps the user takes while running. Those skilled in the art will recognize that a variety of characteristic models could be generated and modified to reflect various ambulatory modes of a variety of users, such as walking, power-walking, jogging, running, or sprinting. Those skilled in the art will also recognize that the provided pedometer information regarding the user could include such information as the aforementioned characteristic model of pedometer accelerometer data, the number of steps taken with or without reference to a given time period, the percentage of user physical activity spent in various ambulatory modes, and/or other pedometer information.

In a yet further approach, the pedometer information regarding the user could be outputted. By various approaches, the pedometer information regarding the user could be output by at least locally providing the pedometer information in a user perceivable form and/or by storing the pedometer information. In a still further approach, locally providing the pedometer information in a user perceivable form may include, at least in part, rendering the pedometer information in audible form. As an illustrative example, the pedometer information could be provided as an audible sound through the aforementioned audio transducer of the headpiece. Those skilled in the art will recognize that locally providing the pedometer information could take a wide variety of forms, and that such forms may be scalable to include providing the pedometer information to other local users. Those skilled in the art will further recognize that storing the pedometer information is scalable to include storing the information locally or remotely, in one or more storage devices or media.

By yet another approach, the pedometer information could be used to automatically formulate a recommendation to the user regarding subsequent user physical activity, e.g. encouraging the user to devote more of his or her exercise regimen to running instead of walking, or recommending that the user spend less time being sedentary.

The approaches described herein provide for a pedometer integrated into a headset along with a personal communications device interface. As a result, the user may be less encumbered by a variety of different personal devices. Additionally, data from the pedometer may be more conveniently obtained via audible or other output as opposed to removing the pedometer to read it, thereby also reducing the likelihood of errors in pedometer data. Furthermore, combination with other sensors and electronics may allow for leveraging of the pedometer accelerometer data and signal processor to facilitate an efficient combination and/or fusion of multiple functions. Also, the device and method described herein are scalable to encompass, among other things, coordination and communication among a number of users, thereby helping different members of, for example, an exercise group to provide encouragement to each other in their work-out regimens.

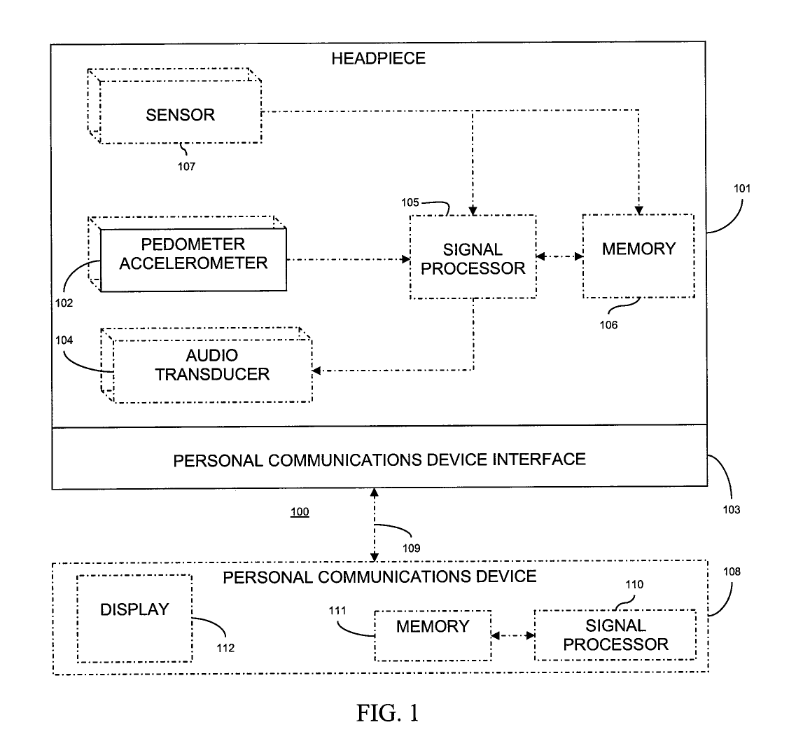

These and other benefits may become clearer upon making a thorough review and study of the following detailed description. Referring now to the drawings, and in particular to FIG. 1, the device 100 includes a headpiece 101 having an integrated pedometer accelerometer 102 and a personal communications device interface 103. (For the sake of clarity, all of the possible connections and interconnections between the personal communications device interface 103 and various headpiece electronics 102, 104-107 are not shown.) Numerous accelerometers suitable for such use are known in the art. As these teachings are not particularly sensitive to the selection of any particular choice in this regard (aside from selecting an accelerometer having a form factor and size that will suit the needs of a given application setting), for the sake of brevity further elaboration in this regard will not be presented here. The pedometer accelerometer 102 may be in communication with any of the personal communications device interface 103, the signal processor 105, and a memory 106.

At least one audio transducer 104 may be included in the headpiece 101. The audio transducer 104 may be used to output data in an audible form from a signal processor 105 and/or the personal communications device interface 103. Various such transducers are well known in the art. If desired, a memory 106 may be provided in communication with the signal processor 105. This memory 106, when provided, can comprise an integral part of the apparatus or can, if desired, comprise a readily removable component. Examples in this regard might presently include, for example, flash memories of various kinds including but not limited to Secure Digital (SD) cards as are well known and understood in the art.

At least one other sensor 107 may be provided in communication with any of the personal communications device interface 103, the signal processor 105, and the memory 106. This sensor 107 may include a non-pedometric biosensor or any other non-pedometric sensor of choice. Examples in this regard include, but are not limited to, sensors to detect the wearer's pulse and/or heart beat, body temperature, galvanic skin response, brain waves, and so forth with other examples being possible as well. Such sensors are known in the art and others that can be employed compatibly with these teachings are likely to be developed going forward as well. In some cases, if desired, two or more of these sensors can share one or more enabling components. As but one example in this regard, the aforementioned accelerometer can serve to inform not only the pedometric functionality of this apparatus but also may facilitate the correction of motion artifacts in the readings of selected sensors such as, but not limited to, heart beat sensors.

The device 100 may also include (or operate in conjunction with) a personal communications device 108 that interfaces 109 with the personal communications device interface 103. Various personal communications devices are known in the art that will work compatibly with these teachings in this regard. Examples include, but are not limited to, two-way wireless devices such as cellular telephones, push-to-talk devices (such as, for example, public safety walkie talkies), one-way and two-way data-only devices (such as pagers, wireless email platforms, and so forth), wireless Internet access devices, and so forth.

This personal communications device 108 may be physically separate from or physically connected (via, for example, a corresponding electrical conductor, optical fiber, or the like) with the headpiece 101. The personal communications device 108 may additionally include a signal processor 110 in communication with a memory 111 to facilitate, if desired, processing data from any of the sensor 107, the pedometer accelerometer 102, and/or the memories 106 and 111. This signal processor 110 can comprise, as desired, a fixed-purpose hard-wired platform or a partially or wholly programmable platform as are known in the art.

A display 112 may also be included in the personal communications device 108 to serve as a visual output for any of the personal communications device 108, the signal processors 105 and 110, and the personal communications device interface 103. The audio transducer may also serve as an input or output for the personal communications device 108 and the personal communications device signal processor 110. The personal communications device signal processor 110 and memory 111 may serve any of the functions performed by the headpiece signal processor 105 and memory 106 as desired.

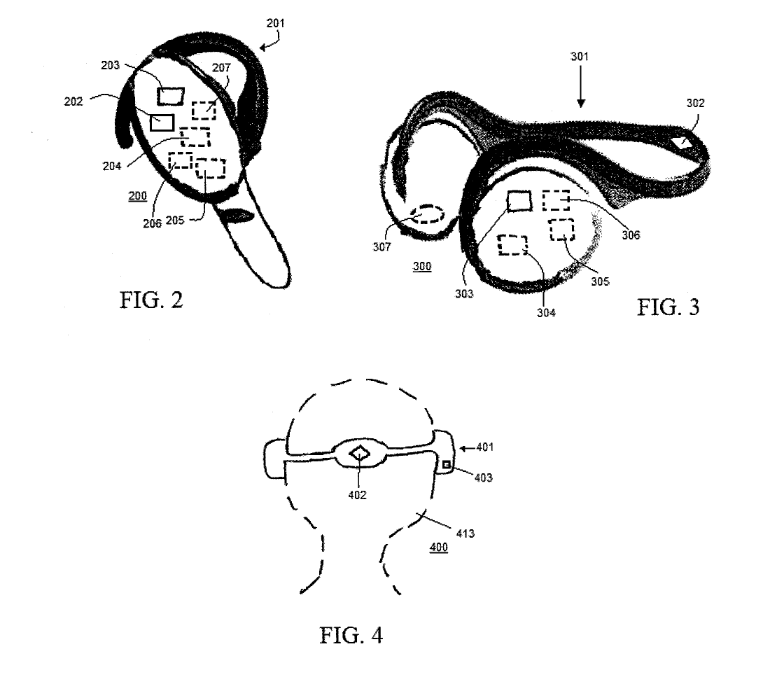

As an illustrative example and with reference to FIG. 2, the device 200 may take the form of a wireless earpiece 201. In this approach, the pedometer accelerometer 202 is disposed integrally with respect to the earpiece 201. The personal communications device interface 203, such as for example a Bluetooth interface, is also disposed on, in, or otherwise carried by the earpiece 201. An audio transducer 204, such as for example a speaker or microphone, may also be disposed on or in the earpiece 201. In addition, one or more non-pedometric sensors 207, such as a heart rate sensor, temperature sensor, or acoustic sensors, may be disposed in the earpiece 201 to gather non-pedometric data.

A signal processor 205 in communication with a memory 206 may be disposed in the earpiece 201 to process signals passing to or from at least one of the pedometer accelerometer 202, the personal communications device interface 203, the audio transducer 204, and/or the memory 206. Those skilled in the art will understand that the signal processor 205 could alternately be provided physically separate from the earpiece 201, but in communication with the other electronic components via the personal communications device interface 203. Those skilled in the art will also understand that processing duties could be allocated between one or more signal processors 205 disposed on or physically separate from the earpiece 201. As such architectural options are well understood by those skilled in the art, further explanation here in that regard is unnecessary.

As a further illustrated example and with reference to FIG. 3, the device 300 may alternatively take the form of a pair of earphones 301. In this approach, the pedometer accelerometer 302 may be disposed integrally with respect to one (or both) of the earphones 301. The personal communications device interface 203, is also disposed on or in the pair of earphones 301. One or more audio transducers 304 may also be disposed on or in one or more of the earpieces. As in the above examples, the device 300 may be further provided with any of one or more non-pedometric sensors 307, a signal processor 305, and/or a memory 306. Also as above, one or more signal processors 305 and memories 306 may be disposed on or physically separate from the pair of earphones 301.

With reference now to FIG. 4, the device 400 may be so configured that when the headpiece 401 is supported by a user's head 413, the pedometer accelerometer 402 is disposed on the headpiece 401 substantially dorsally with respect to the user's head 413. Other components, such as for example the personal communications device interface 403 may be disposed substantially dorsally with respect to the user's head 413 or elsewhere on the headpiece 401. Such dorsal positioning may be advantageous with respect to at least some application settings. Such positioning of a pedometric sensor may be less susceptible to noise and/or false signaling than other sensor locations for at least some users. This, in turn, may permit the use of less complex signal processing requirements which can lead to reduced platform complexity, power consumption, and so forth.

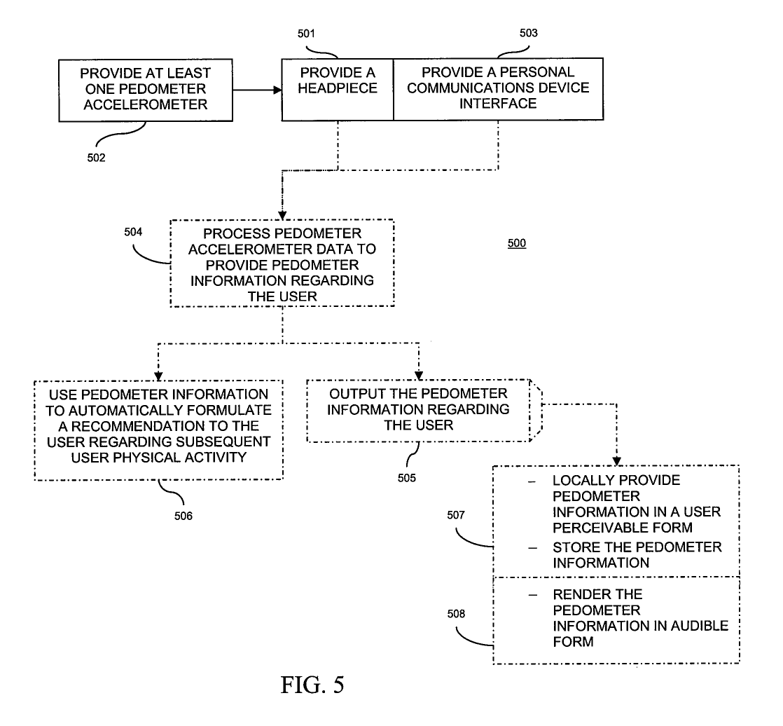

In accordance with various approaches and with reference to FIGS. 1 and 5, a headpiece configured and arranged to be supported by a user's head 101 is provided 501 and a pedometer accelerometer 102 is provided 502 integrally disposed with respect to the headpiece 101. A personal communications device interface 103 is provided 503 in conjunction with the headpiece 101. By various approaches, a signal processor 105 may be used to process pedometer accelerometer data to provide pedometer information regarding the user 504, as discussed above.

By one approach the pedometer information regarding the user may be output 505, such as for example by locally providing 507 the pedometer information in a user perceivable form (such as by making use of a display 112 or rendering 508 the pedometer information in audible form through one or more audio transducers 104) or storing the pedometer information (such as for example in at least one memory 106 and 111, locally or remotely).

Such information might comprise, for example, data regarding a number of steps as have been cumulatively and/or recently taken by the user. Such information could also comprise, as desired, data regarding a particular distance that the user has traveled. In either case, such information can be provided in response to a specific inquiry by the user (via, for example, asserting a corresponding button (not shown) and/or recognition of a voiced command by the user using a corresponding microphone). These teachings will also accommodate providing such information on an automatic basis. This might comprise, for example, providing a step and/or distance report upon achieving some particular goal or milestone relating to steps taken and/or distance traveled. This could also comprise, if desired, providing such a report pursuant to some predetermined schedule (such as every fifteen minutes, every hour, once a day at some particular time, or the like).

Those skilled in the art will recognize and appreciate that such information, when stored, can be compared and contrasted with previously stored information of similar kind. This, in turn, can permit (for example) present activities and performance to be compared and contrasted with historical efforts and achievements in order to determine relative levels or rates of improvement (or the lack of such improvement). As already noted above, such information can be stored locally or remotely and, accordingly, such processing can be similarly performed on a local or remote basis as desired.

In yet another approach, the pedometer information may be used to automatically formulate a recommendation to the user regarding subsequent physical activity 506. For example, if the user were substantially immobile for a long period of time, a recommendation may be formulated to the user to get up and walk around. As a further example, a recommendation may be formulated to a user who exercises only by walking that he or she spend more time jogging or running. This formulation 506 may be performed by one or more signal processors 105 and 110 or by another calculations platform.

By one approach, these teachings will accommodate using one or more ambulatory models to better facilitate detecting and interpreting pedometric data as alluded to above. Such models can be developed using any desired approach. For example, by one approach, such a model can be developed by trained personnel when testing the user in a clinical setting. As another example, such a model (or models) can be developed using one or more automated processes such as the aforementioned learning mode of operation. As one simple illustration in this regard, the user could place the apparatus into a learning mode of operation and then indicate a particular ambulatory state, such as “running.” The user could then engage in running and the apparatus could use the detected pedometric data to form a corresponding running-state model. A similar approach could be used to develop, for example, a walking-state model.

Such models could then be selected for use during ordinary operation of the apparatus. This might comprise, for example, the user themselves selecting a particular model to be employed. This could also comprise, however, the apparatus itself automatically determining which model seemed best applicable in a given application setting. Such a determination might be based, for example, upon an average time that elapses between stride events (where, for example, strides of longer duration are indicative of walking while strides of shorter duration are indicative of running). This, in turn, will permit the apparatus to select, for example, a particular stride distance to employ when calculating a total distance traveled by the user. For example, when using a running-state model, the stride distance might be 36 inches whereas a walking-state model might have a corresponding stride distance of only 28 inches.

By yet another approach, these teachings will accommodate verifying the likely accuracy of using a particular model as described above. These teachings will accommodate using essentially any possibly relevant information in this regard. As one example in this regard, the apparatus may receive biosensor information regarding the user's heart rate. This heart rate information, in turn, can serve to verify whether pedometric data that would appear to correspond to running is in fact being gathered while the user runs (presuming that the user's heart rate will vary with respect to the user's ambulatory activities in a relatively reliable manner). Such information can serve to then better inform the selection of a particular pedometric ambulatory-state model to employ at a particular point in time. Those skilled in the art will understand that other biosensor information, such as for example the user's temperature, galvanic skin response, hydration levels and so forth may similarly serve to verify pedometric data and inform the selection of a pedometric ambulatory-state model (presuming as above that the biosensor information will vary with respect to the user's ambulatory activities in a relatively reliable manner).

As another example in this regard, the aforementioned personal communications device may contain useful information such as the user's calendar of scheduled appointments and activities. In such a case, a calendar entry regarding the user being scheduled to visit their health club could be used to verify usage of a running-model pedometric data processing state as versus, for example, a walking-model state.

As yet another example in this regard, the apparatus may receive information regarding the user's location, such as for example GPS information. In such a case, a rapid change in the user's location could be used to verify usage of a running-model pedometric data processing state as versus, for example, a walking-model state.

It should be well appreciated that the aforementioned device and method provide for the convenient integration of a pedometer with other personal devices, thereby reducing the number of devices a user may carry. This may be particularly important to joggers or runners who may wish to avoid needless encumbrances. Furthermore, the placement of the pedometer in the headset, along with a variety of potential output modes, may be more convenient for the user and provide for less interruption or errors in the pedometer data. Combining the pedometer accelerometer and a signal processor with other sensors and devices may provide for synergistic leveraging of the accelerometer data and signal processor, such that the same data and components are put to use in a variety of functions. As previously noted, the device and method described herein are scalable to facilitate coordination and communication among a number of users, thereby potentially helping different users to keep pace with each other.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one illustrative example in this regard, when the apparatus comprises a removable memory (such as an SD card) as mentioned above, if desired, these teachings may be employed in a context where the personal communications device interface is essentially avoided. Instead, the removable memory can serve as a vehicle for moving the pedometer data to a remote storage (and/or processing) platform of choice. It will also be appreciated that the memory in such an apparatus (removable or otherwise) can contain other content, such as, but not limited to music. In such a case, the apparatus can include additional corresponding components (such as an audio amplifier and headphone jack) to permit an end user to listen to music while wearing and using the apparatus for its other intended purposes as well.

As yet another example in this regard, many personal communications devices presently include a global positioning system (GPS) receiver. So equipped, the device can receive GPS signals from corresponding satellites and hence calculate its present geographic location. This information, in turn, can be used for a variety of purposes including navigation, presence-based services, 911 location support, and so forth. Unfortunately, GPS signals are often highly degraded or even absent in urban canyons and/or interior spaces. In such a case, if desired, the pedometer information developed pursuant to these teachings can be readily employed with existing dead reckoning techniques to supplement such location information under such circumstances by such a device.

We claim:

1. An apparatus comprising:
a headpiece configured and arranged to be supported by a user's head;
at least one pedometer accelerometer integrally disposed with respect to the headpiece;
a personal communications device interface operably supported by the headpiece.

2. The apparatus of claim 1 wherein the headpiece comprises, at least in part, an earpiece comprising at least one audio transducer.

3. The apparatus of claim 2 wherein the at least one pedometer accelerometer is disposed substantially dorsally with respect to the user's head when the headpiece is supported by the user's head.

4. The apparatus of claim 1 wherein the personal communications device interface comprises at least one of:
a wireless interface;
a non-wireless interface.

5. The apparatus of claim 4 wherein the personal communications device interface is configured and arranged to locally interface with a personal communications device.

6. The apparatus of claim 5 wherein the personal communications device interface is further configured and arranged to transmit pedometer information regarding the user to the personal communications device.

7. The apparatus of claim 6 wherein the personal communications device interface is further configured and arranged to receive processed pedometer information regarding the user from the personal communications device.

8. The apparatus of claim 1 further comprising:
a signal processor operably coupled to the pedometer accelerometer.

9. The apparatus of claim 8 further comprising:
at least one non-pedometric biosensor integrally disposed with respect to the headpiece.

10. The apparatus of claim 9 wherein the at least one non-pedometric biosensor comprises, at least in part, a heart rate sensor.

11. The apparatus of claim 9 wherein the signal processor is configured and arranged, at least in part, to process both pedometer accelerometer data and non-pedometric biosensor data as a function, at least in part, of data from the pedometer accelerometer.

12. The apparatus of claim 8 wherein the signal processor is configured and arranged to selectively operate in each of a learning mode of operation and a normal mode of operation, wherein the learning mode of operation comprises, at least in part, developing at least one characteristic model of pedometer accelerometer data as corresponds to at least one ambulatory mode of the user.

13. The apparatus of claim 12 wherein the normal mode of operation comprises, at least in part, using the at least one characteristic model of pedometer accelerometer data to process pedometer accelerometer data.

14. The apparatus of claim 8 wherein the signal processor is configured and arranged to substantively verify processed pedometer data as a function, at least in part, of non-pedometric data.

15. A method comprising:
providing a headpiece configured and arranged to be supported by a user's head;
providing at least one pedometer accelerometer that is integrally disposed with respect to the headpiece;
providing a personal communications device interface in conjunction with the headpiece.

16. The method of claim 15 further comprising:
processing pedometer accelerometer data to provide pedometer information regarding the user.

17. The method of claim 16 further comprising:
outputting the pedometer information regarding the user.

18. The method of claim 17 wherein outputting the pedometer information regarding the user comprises at least one of:
locally providing the pedometer information in a user perceivable form;
storing the pedometer information.

19. The method of claim 18 wherein locally providing the pedometer information in a user perceivable form comprises, at least in part, rendering the pedometer information in audible form.

20. The method of claim 16 further comprising using pedometer information to automatically formulate a recommendation to the user regarding subsequent user physical activity.
